(19) United States
(12) Patent Application Publication
(10) Pub. No.: US 2007/0019726 A1
(43) Pub. Date: Jan. 25, 2007

(54) Method and apparatus for encoding and decoding video signal by extending application of directional intra-prediction

(75) Inventors: Sang-chang Cha, Hwaseong-si (KR); Kyo-hyuk Lee, Seoul (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/490,035

(22) Filed: Jul. 21, 2006

Related U.S. Application Data
(60) Provisional application No. 60/701,037, filed on Jul. 21, 2005.

(30) Foreign Application Priority Data
Nov. 17, 2005 (KR) 10-2005-0110274

(51) Int. Cl. H04N 7/12; H04N 11/04

(52) U.S. Cl. 375/240.12; 375/240.24

(57) ABSTRACT

A method and apparatus for encoding and decoding a video signal by extending an application of directional intra-prediction. When performing a directional intra-prediction during video data encoding, a second block in a frame is searched in order to predict information of a first block included in the video data from the second block existing in the same frame as the first block, a residual between information included in the searched second block and the information included in the first block is calculated, and the calculated residual is encoded. The second block exists in a position adjacent to the first block, and the first block refers to the second block in a third direction existing between a first direction and a second direction that are adjacent to each other for use in the directional intra-prediction.

### CROSS-REFERENCE TO RELATED APPLICATIONS

This application claims priority from Korean Patent Application No. 10-2005-0110274 filed on Nov. 17, 2005 in the Korean Intellectual Property Office, and U.S. Provisional Patent Application No. 60/701,037, filed on Jul. 21, 2005, the disclosures of which are incorporated herein by reference in their entirety.

### BACKGROUND OF THE INVENTION

1. Field of the Invention

Methods and apparatuses consistent with the present invention relate to video encoding and decoding, and more particularly to encoding and decoding a video signal by extending an application of directional intra-prediction.

2. Description of the Prior Art

Since multimedia data which includes text, moving pictures (hereinafter referred to as “video”) and audio is typically large, mass storage media and wide bandwidths are required for storing and transmitting the data. Accordingly, compression coding techniques are required to transmit multimedia data. Among multimedia compression methods, video compression methods can be classified into lossy/lossless compression, intraframe/interframe compression, and symmetric/asymmetric compression, depending on whether source data is lost, whether compression is independently performed for respective frames, and whether the same time is required for compression and reconstruction, respectively. In the case where frames have diverse resolutions, the corresponding compression is called scalable compression.

The purpose of conventional video coding is to transmit information that is optimized to a given transmission rate. However, in a network video application such as Internet streaming video, the performance of the network is not constant, but varies according to circumstances, and thus flexible coding is required in addition to the coding optimized to the specified transmission rate.

Scalability is the ability of a decoder to selectively decode a base layer and an enhancement layer according to processing conditions and network conditions. In particular, fine granularity scalable (FGS) methods encode the base layer and the enhancement layer, and the enhancement layer may not be transmitted or decoded depending on the network transmission efficiency or the state of a decoder side. Accordingly, data can be properly transmitted according to the network transmission rate.

FIG. 1 illustrates an example of a scalable video codec using a multilayer structure. In this video codec, the base layer is in the Quarter Common Intermediate Format (QCIF) at 15 Hz (frame rate), the first enhancement layer is in the Common Intermediate Format (CIF) at 30 Hz, and the second enhancement layer is in the SD (Standard Definition) format at 60 Hz. If CIF 0.5 Mbps stream is required, the bit stream is truncated to obtain a bit rate of 0.5 Mbps based on a first enhancement layer having a CIF, a frame rate of 30 Hz and a bit rate of 0.7 Mbps. In this method, spatial and temporal SNR scalability can be obtained.

As shown in FIG. 1, frames (e.g., 10, 20 and 30) in respective layers, which have the same temporal position, have images similar to one another. Accordingly, a method of predicting texture of the current layer and encoding the difference between the predicted value and the actual texture value of the current layer has been proposed. In the Scalable Video Mode 3.0 of ISO/IEC 21000-13 Scalable Video Coding (hereinafter referred to as “SVM 3.0)”, such a method is called intra-BL prediction.

According to SVM 3.0, in addition to inter-prediction and directional intra-prediction used for predicting blocks or macroblocks that constitute the current frame in the existing H.264, a method of predicting the current block by using the correlation between the current block and a corresponding lower-layer block has been adopted. This prediction method is called “intra-BL prediction”, and a mode for performing encoding using such a prediction method is called an “intra-BL mode”.

FIG. 2 is a view schematically explaining the above-described three prediction methods. First (\textcircled{1}) intra-prediction is performed with respect to a certain macroblock 14 of the current frame 11, second (\textcircled{2}) inter-prediction is performed using a frame 12 that is at a temporal position different from that of the current frame 11, and third (\textcircled{3}) intra-BL prediction is performed using texture data for an area 16 of a base-layer frame 13 that corresponds to the macroblock 14.

The intra-BL prediction may be efficient in obtaining a reasonable performance according to the conventional intra-prediction technology. However, the unit of quantization for each layer in a multilayer structure may differ, and this may cause the type of data required for each layer to differ. In this case, a better performance can be obtained through the directional intra-prediction. Thus, an encoding and decoding method and an apparatus that performs an intra-prediction to match the characteristics of the multilayer are required.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and an apparatus for encoding and decoding of an enhancement layer by directional intra-prediction using texture and symbol information of a base layer.

The present invention also provides a method and an apparatus for extending directionality of directional intra-prediction using bits reduced according to the use of the information of the base layer.

According to an aspect of the present invention, there is provided a method of performing directional intra-prediction when encoding video data, which includes searching for a second block in a frame in order to predict information of a first block included in the video data from the second block existing in the same frame as the first block; calculating a residual between information of the second block and the information of the first block; and encoding the calculated residual, wherein the second block exists in a position adjacent to the first block, and the first block refers to the second block in a third direction existing between a first direction and a second direction which are adjacent to each other for use in the directional intra-prediction according to H.264 intra-prediction direction structure.

In another aspect of the present invention, there is provided a method of decoding video data encoded according to directional intra-prediction, which includes decoding residual data of a first block included in the video data; predicting video information of the first block by referring to a second block included in the same frame as the first block; and restoring video information of the first block by adding the residual data and the predicted video information, wherein the second block exists in a position adjacent to the first block, and the first block refers to the second block in a third direction existing between a first direction and a second direction which are adjacent to each other for use in the directional intra-prediction. Here, each of the first and second directions may correspond to one of eight H.264 intra-prediction directions

In still another aspect of the present invention, there is provided a method of hierarchically encoding video data, which includes quantizing data of a lower layer; calculating a first error range produced in the quantization process of the lower layer; and quantizing data of an enhancement layer. Here, the quantization of the data of an enhancement layer is not performed with respect to a quantization area corresponding to the first error range, and the quantized data of the enhancement layer is disposed in an area having a second error range which does not overlap the first error range.

In still another aspect of the present invention, there is provided a method of hierarchically decoding video data, which includes dequantizing data of a lower layer; and dequantizing an upper layer which refers to the lower layer; wherein a second error range of the upper layer succeeds a first error range of the lower layer without overlapping the first error range.

In still another aspect of the present invention, there is provided a video encoder for performing directional intra-prediction when encoding video data, which includes a reference block prediction unit searching for a second block in a frame in order to predict information of a first block included in the video data from the second block existing in the same frame as the first block; and a residual encoding unit calculating a residual between information of the second block and the information of the first block, and encoding the residual, wherein the second block exists in a position adjacent to the first block, and the reference block prediction unit searches for the second block in a third direction existing between a first direction and a second direction which are adjacent to each other for use in the directional intra-prediction when searching for the second block which the first block refers to.

In still another aspect of the present invention, there is provided a video decoder for decoding video data encoded according to directional intra-prediction, which includes a residual decoding unit decoding residual data of a first block included in the video data; a directional intra-prediction unit predicting video information of the first block by referring to a second block included in a same frame as the first block; and a restoration unit restoring video information of the first block by adding the residual data and the predicted video information, wherein the second block is adjacent to the first block, and the first block refers to the second block in a third direction existing between a first direction and a second direction which are adjacent to each other for use in the directional intra-prediction.

### BRIEF DESCRIPTION OF THE DRAWINGS

The above and other aspects of the present invention will become more apparent from the following detailed description of exemplary embodiments taken in conjunction with the accompanying drawings, in which:

FIG. 1 is a view illustrating an example of a scalable video codec using a multilayer structure;

FIG. 2 is a view schematically explaining three prediction methods;

FIGS. 3A and 3B are views explaining existing intraprediction directions and extended intra-prediction directions according to an exemplary embodiment of the present invention;

FIG. 4 is a view explaining relations among blocks which are referred to based on an extended intra-prediction according to an exemplary embodiment of the present invention;

FIG. 5 is a view explaining an example of prediction by giving weightings to blocks according to the extended intra-prediction as illustrated in FIG. 4;

FIG. 6 is a view explaining the calculation of the most probable mode from plural adjacent blocks according to an exemplary embodiment of the present invention;

FIG. 7 is a view explaining the calculation of the most probable mode based on angles according to an exemplary embodiment of the present invention;

FIG. 8 is a view explaining an example of coding directional symbols based on information re-evaluated using a texture of a base layer according to an exemplary embodiment of the present invention;

FIG. 9 is a view explaining an example of adjusting an error range that may be produced between layers according to an exemplary embodiment of the present invention;

FIG. 10 is a flowchart illustrating an encoding process according to an exemplary embodiment of the present invention;

FIG. 11 is a flowchart illustrating a decoding process according to an exemplary embodiment of the present invention;

FIG. 12 is a block diagram illustrating the construction of a video encoder according to an exemplary embodiment of the present invention; and

FIG. 13 is a block diagram illustrating the construction of a video decoder according to an exemplary embodiment of the present invention.

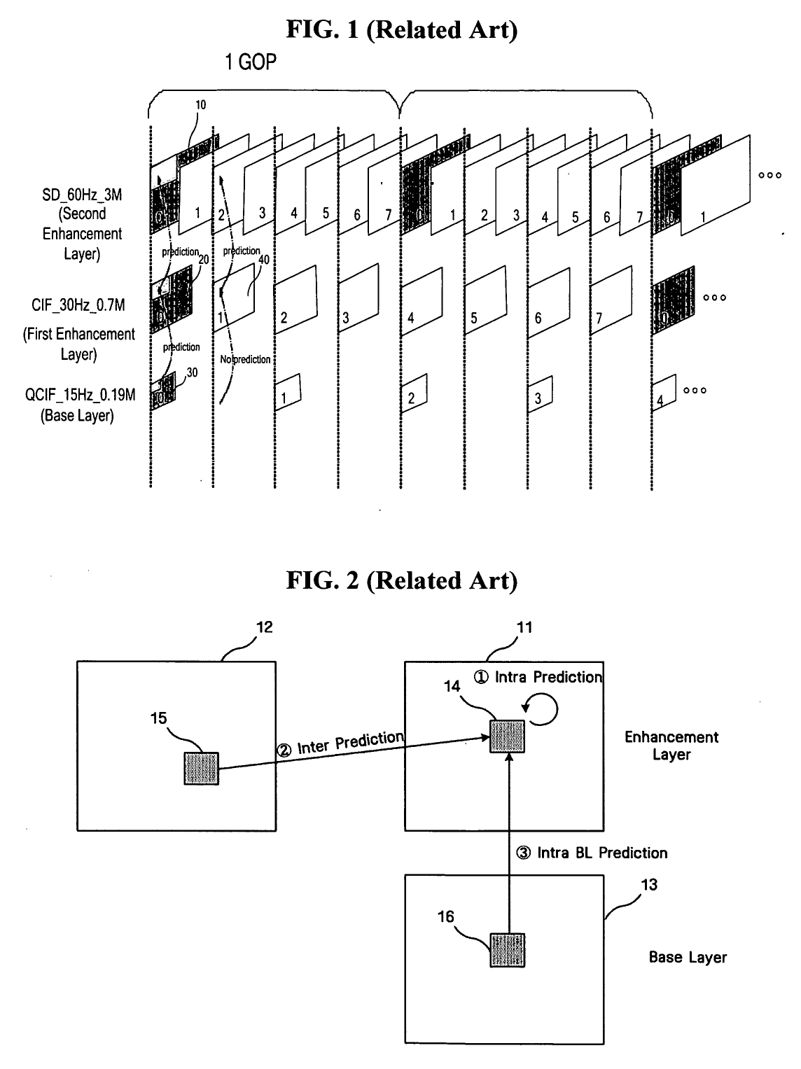

### DETAILED DESCRIPTION OF THE EXEMPLARY EMBODIMENTS

Hereinafter, exemplary embodiments of the present invention will be described in detail with reference to the accompanying drawings. The aspects and features of the present invention and methods for achieving the aspects and features will become apparent by referring to the exemplary embodiments to be described in detail with reference to the accompanying drawings. However, the present invention is not limited to the exemplary embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

Exemplary embodiments of the present invention will be described with reference to the accompanying drawings illustrating block diagrams and flowcharts for explaining a method and apparatus for encoding and decoding a video signal by extending an application of directional intra-prediction according to the present invention. It will be understood that each block of the flowchart illustrations and combinations of blocks in the flowchart illustrations can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

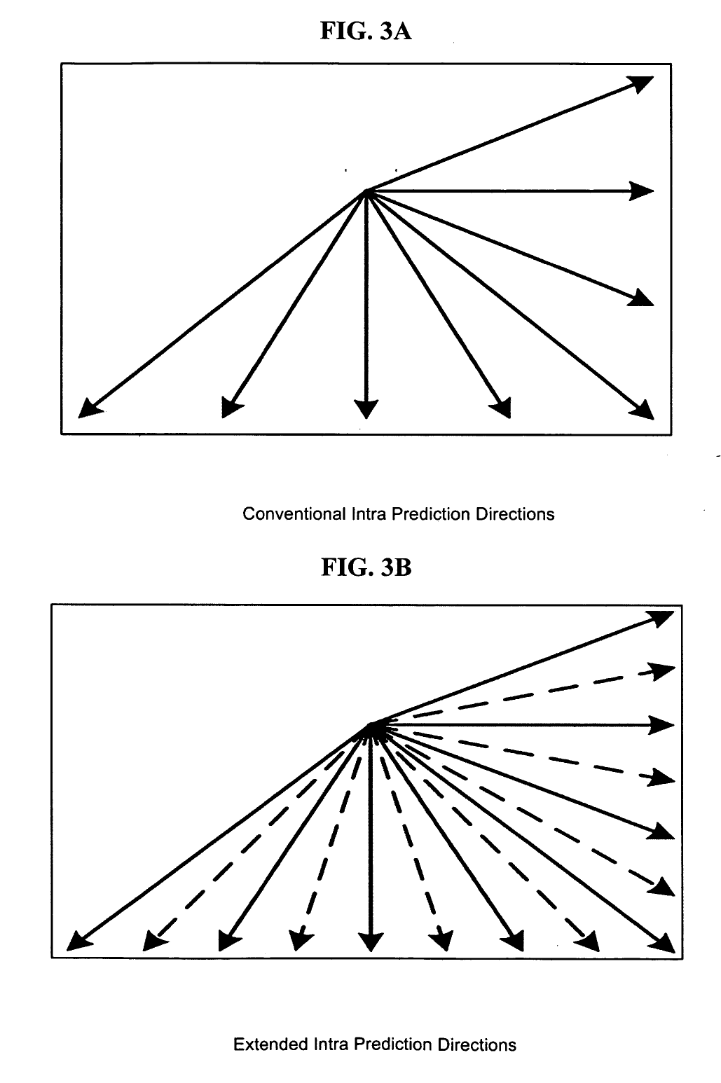

FIGS. 3A and 3B are views explaining existing intraprediction directions and extended intra-prediction directions according to an exemplary embodiment of the present invention.

If layers have different spatial resolutions or deltaQp becomes large between the layers, the texture of a base layer is not suitable to predict the current layer (or enhancement layer). Also, if the quantization of the enhancement layer is non-regular, the number of directions in the directional intra-prediction proposed in H.264 specifications may be not suitable for the prediction. According to an exemplary embodiment of the present invention, directions for the directional intra-prediction are extended as shown in FIG. 3B. In other words, directions for the extended intra-prediction shown as dashed lines in FIG. 3B are added among directions for the existing intra-prediction shown as solid lines in FIG. 3A.

The directional intra-prediction proposed in the H.264 specifications has 9 directions including 8 directions as illustrated in the drawing and DC. The extended directional intra-prediction proposed according to an exemplary embodiment of the present invention adds 7 more directions, and thus the entire number of intra-prediction directions is 16. By adding information on intra-BL4×4 to the 16 directions, the number of intra-prediction directions becomes 17 in total. According to the extended intra-prediction in the exemplary embodiment of the present invention, information, which cannot be accurately indicated by the existing directionality, is indicated through the extended directionality, and thus the performance of the intra-prediction is improved. As a result, the intra-prediction can be applied in the case where the intra-BL for the base layer fails to have a high compression rate due to the difference in resolution or quantization size between the base layer and the enhancement layer.

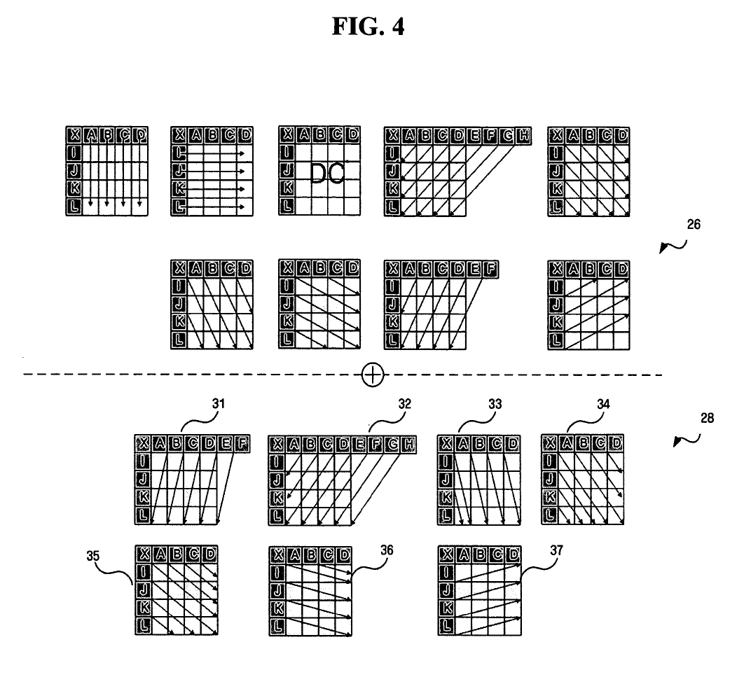

FIG. 4 is a view explaining relations among blocks that are referred to based on the extended intra-prediction as described above according to an exemplary embodiment of the present invention. Reference numeral 26 in FIG. 4 shows blocks that are referred to for the intra-prediction in the conventional H.264. According to the extended intra-prediction, adjacent blocks indicated as a reference numeral 28 in FIG. 4 are referred to according to the extended intra-prediction directions as shown in FIG. 3B. In this case, weightings must be given to adjacent pixels. Blocks 31, 32, 33, 34, 35, 36, and 37 in FIG. 4, which include subblocks, show the relations among the adjacent pixels that are referred to during the extended intra-prediction.

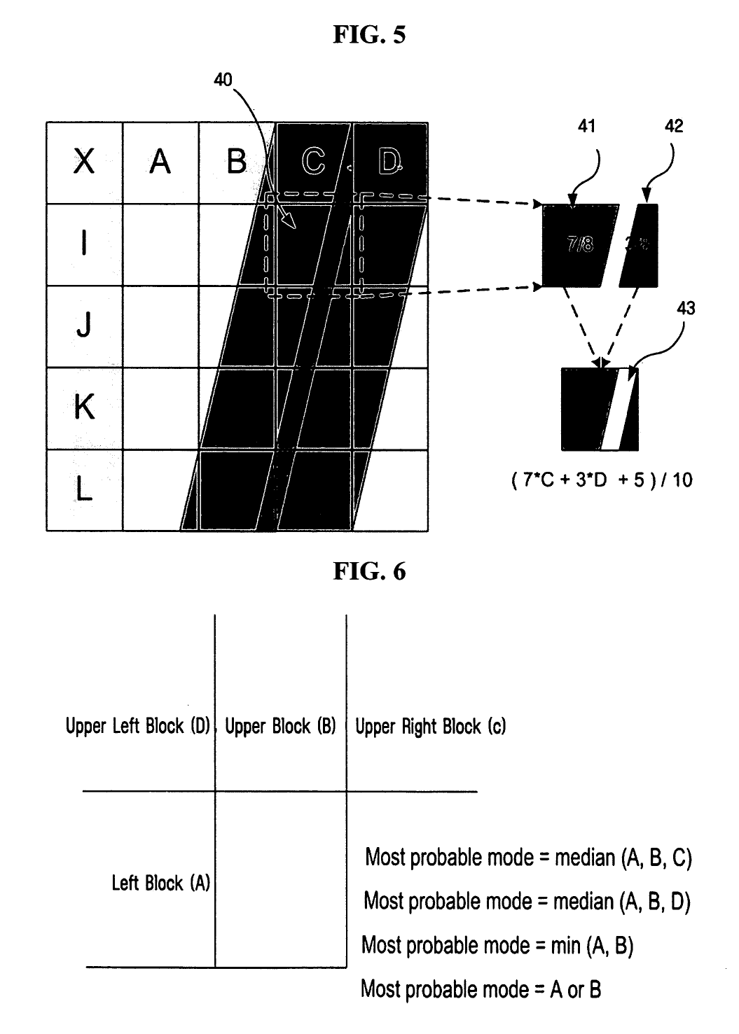

FIG. 5 is a view explaining an example of prediction by giving weightings to blocks according to the extended intra-prediction as illustrated in FIG. 4. In the case of using the intra-prediction, the current pixel can be calculated by calculating the results from applying weight values to the adjacent pixels. The levels of weight values given to the adjacent pixels can be judged by areas occupied by the corresponding pixels, respectively, as shown in FIG. 5.

Referring to FIG. 5, pixels C and D affect a pixel 40. Specifically, the reference numerals 41 and 42 indicate parts of the pixel 40 affected by the pixels C and D, and the reference numeral 43 indicates an overlapping part between the parts 41 and 42. Accordingly, the pixel 40 can be predicted by determining the contribution rate of the pixel parts 41 and 42 as 7:3, determining the contribution degree of the overlapping part 43 as 5, and then calculating (7×C+3×D+5)/10.

As shown in FIG. 4, in order to perform the intra-prediction, 17 directions, which include 15 directions as indicated in FIG. 3B, DC, and intraBL4×4, are required. In order to efficiently indicate information on the 17 directions, 1+4 bits are required: one bit for indicating the most probable mode, and four bits for indicating the 16 directions including DC. In the case where the most probable mode is “1”, the value of rem_intra4×4_pred mode in Table 1 below matches an actual prediction mode indicated on the left in Table 1. Since the information is set by 1+4 bits, the upper one bit indicates the value of the most probable mode, and the lower four bits indicate the rem_intra4×4_pred mode.

TABLE 1
Video Coding Modes

| Most Probable Mode | rem_intra4x4_pred |
|---|---|
| for Current Block | mode |
| 0 | 0 |
| 2 | 1 |
| 3 | 2 |
| 4 | 3 |
| 5 | 4 |
| 6 | 5 |
| 7 | 6 |
| 8 | 7 |
| 9 | 8 |
| 10 | 9 |
| 11 | 10 |
| 12 | 11 |
| 13 | 12 |
| 14 | 13 |
| 15 | 14 |
| 16 | 15 |
| 17 | 16 |

FIG. 6 is a view explaining the calculation of the most probable mode from plural adjacent blocks according to an exemplary embodiment of the present invention.

The value of the most probable mode is obtained as the minimum value of upper and left intra-prediction modes. In an exemplary embodiment of the present invention, diverse methods for obtaining the most probable mode value have been proposed. On the assumption that blocks required for the prediction are A, B, C, and D, the most probable mode may have a median of A, B, and C, or a median of A, B, and D. Also, the most probable mode may have a minimum value of A and B, or a value of A or B.

If the blocks to be referred to during the prediction are A, B, and C, or A, B, and D, a median thereof can be used, while if the blocks to be referred to are A and B, the H.264 prediction method can be used. If one block is to be used, the block can be the most probable mode.

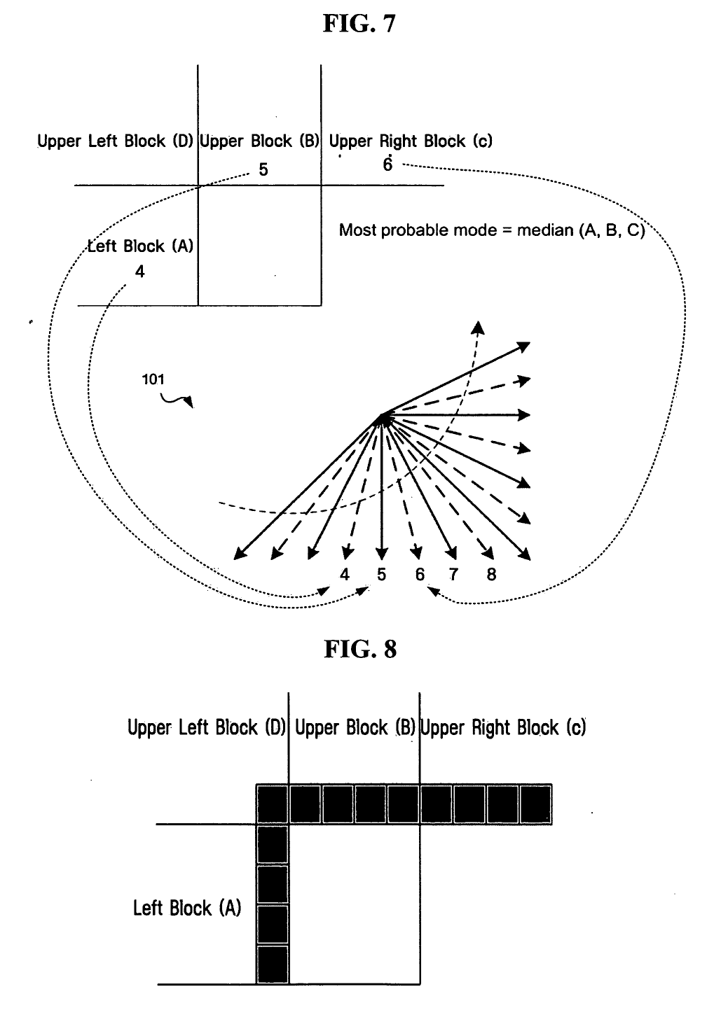

FIG. 7 is a view explaining the calculation of the most probable mode based on angles according to an exemplary embodiment of the present invention.

Referring to FIG. 7, the most probable mode is calculated using three blocks. In this case, the most probable mode can be calculated based on the directions of the extended directional intra-prediction as described above. However, in the case of the prediction mode based on the directions, adjacent blocks may have the same or similar values. For example, when the directions of the directional intra-prediction are defined based on the angles, as denoted as 101 in FIG. 7, a left block A, upper block B, and upper right block C may be similar or be related to one another such as they corresponds to a mode 4, mode 5, and mode 6, respectively, in the intra-prediction. Accordingly, when three blocks are applied in order to select the median thereof, the encoding may be performed with respect to the difference between blocks A and B, instead of performing the encoding with respect to the modes 4, 5, and 6. Since the value of block B is larger than that of block A by 1 and the value of block C is larger than that of block B by 1, the size of data to be processed can be reduced by encoding such information regarding the adjacent blocks.

FIG. 8 is a view explaining an example of coding directional symbols based on information revaluated using a texture of a base layer according to an exemplary embodiment of the present invention.

On the assumption that the reconstructed base-layer textures are the original textures, the directions having the minimum bit cost are searched for using neighboring textures of the current layer.

The bit costs for the search, which come from the intra-predictions, correspond to the differences between the neighboring textures of the current layer and the reconstructed textures of the base layer. If the directions that use the neighboring textures of the current layer are searched for, bit costs for all 17 directions (101 in FIG. 7) are compared with one another. For example, if the left block A corresponds to the mode 4 in the intra-prediction, the upper block B corresponds to the mode 5, and the upper right block C corresponds to the mode 6, “5” may be selected as the median of them.

The most probable mode is evaluated using the neighboring (e.g., upper, left, and upper right) textures of the current layer and texture information of the base layer that corresponds to the current layer. In this case, the directions of the minimum bit cost are searched for using the neighboring textures of the current layer on the assumption that the reconstructed base-layer textures are the original textures. For example, the bit costs for the search come from the differences between the neighboring textures of the current layer and the reconstructed base-layer textures. If the directions using the neighboring textures of the current layer are searched for, all 17 directions (including DC component and intraBL4×4) are compared with one another using Equation (1).
Bitcost=(O_{B}−P_{C})+λR (1)

Here, O_{B} denotes the reconstructed base-layer textures, and P_{C} denotes 17 directional intra-predictions using the neighboring textures of the current layer. R is evaluated using a variable length coding (VLC) technique, and λ is a constant. This construction can be seen in FIG. 8.

When three blocks are usable, 13 textures of the neighboring pixels of the current layer may exist. In FIG. 8, each of the left block A, the upper block B, and the upper right block C provides four pixels, and the upper left block D provides one pixel, so that the total number of pixels becomes 13. By applying the above-described 17 directional intra-predictions to the pixels, the bit cost can be reduced.

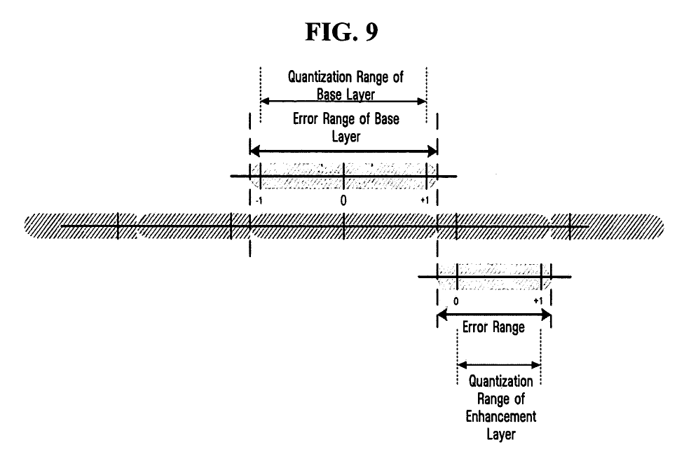

FIG. 9 is a view explaining an example of adjusting an error range that may be produced between layers according to an exemplary embodiment of the present invention. In a multilayer video coding, multi-quantization is necessary for SNR, resolution, and temporal scalability. As illustrated in FIG. 9, the quantization of the enhancement layer is performed in consideration of an error range of the quantization of the base layer. For example, the quantization of the enhancement layer is subject to the error range of the base layer. The error range at the quantization step of the enhancement layer can succeed the error range of the base layer without overlapping it. Also, the entire bit size to be encoded can be reduced by making the error range of the base layer be allocated with no bit.

In FIG. 9, with respect to the enhancement layer, bits may be allocated to “+1” and “0” only, and may not be allocated to “−1”. In this case, the bit size to be encoded is reduced from two bits to one bit. In FIG. 9, in an area included in the error range of the base layer, the quantization of the enhancement layer is not performed. As a result, the quantization is performed through “−1”, “0”, and “+1” on the base layer, while the quantization is performed through the allocation of “0” and “+1” only, without allocating “−1”, on the enhancement layer. Although FIG. 9 shows a case where one enhancement layer is quantized for the base layer, the bits included in the quantization are gradually decreased, and this greatly affects the whole encoding efficiency.

The encoding bits of the current layer can be reduced by combining the range of the quantization bits of the enhancement layer. Also, by improving the playback sequence quality of the current layer, a better base layer can be provided for an upper enhancement layer. This gain can be propagated from the base layer to the uppermost layer.

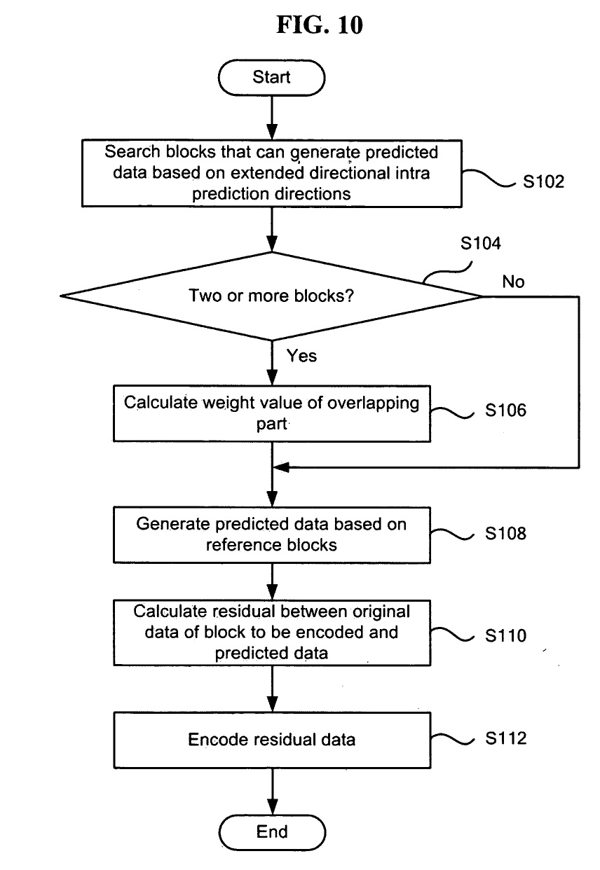

FIG. 10 is a flowchart illustrating an encoding process according to an exemplary embodiment of the present invention.

Referring to FIG. 10, blocks that can produce predicted data based on the extended directional intra-prediction directions are searched for S102. The extended directions include 17 directional intra-predictions as described above. If two or more prediction blocks, which are to be referred to, exist S104, weight values for overlapping or affecting parts of the respective blocks are calculated S106. Then, predicted data is generated based on the reference block S108. If the predicted data is generated, a residual between the original data of the block to be encoded and the predicted data is calculated S110. The, the calculated residual data is encoded S112.

The extended directional intra-prediction directions in step S102 are searched from the adjacent blocks, and exist among the directions proposed in the existing H.264 specifications. In this case, if two or more blocks are used for the prediction, weight values are given for the adjacent blocks according to their sizes affecting the blocks to be encoded, and data for predicting the blocks to be encoded is generated.

In addition, in order to select the most probable mode value, several blocks are referred to as illustrated in FIG. 6. Since the adjacent blocks may have similar directions as illustrated in FIG. 7, the residual between them may be encoded. In the case where three or more blocks are referred to, a median of them may be used.

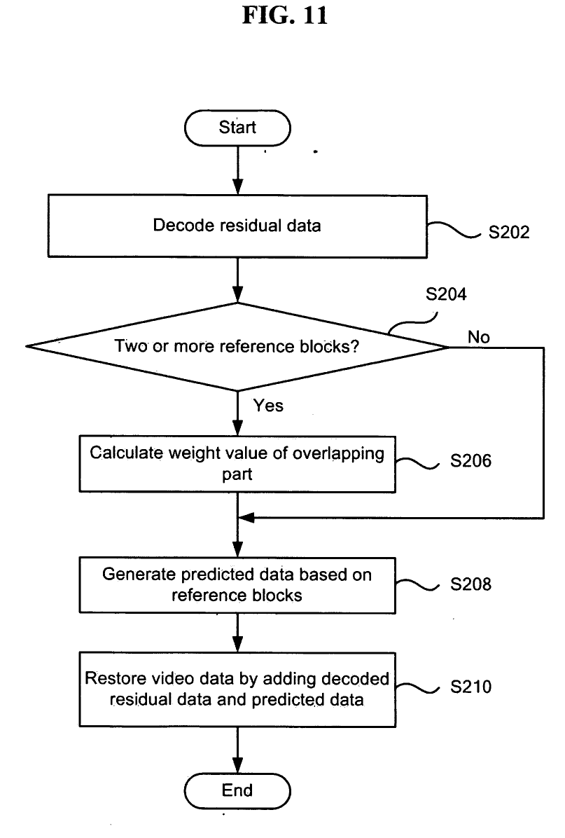

FIG. 11 is a flowchart illustrating a decoding process according to an exemplary embodiment of the present invention.

Referring to FIG. 11, residual data included in a received bitstream is decoded S202. If the decoded residual data has been encoded by the directional intra-prediction and two or more blocks are referred to S204, a process of obtaining weight values is required S206. Predicted data is generated based on the reference blocks S208. Then, video data is restored by adding the decoded residual data and the predicted data S210.

When the residual data is decoded, the most probable mode value is decoded. In this case, the process of determining the most probable mode value may differ according to the referred adjacent blocks as described above.

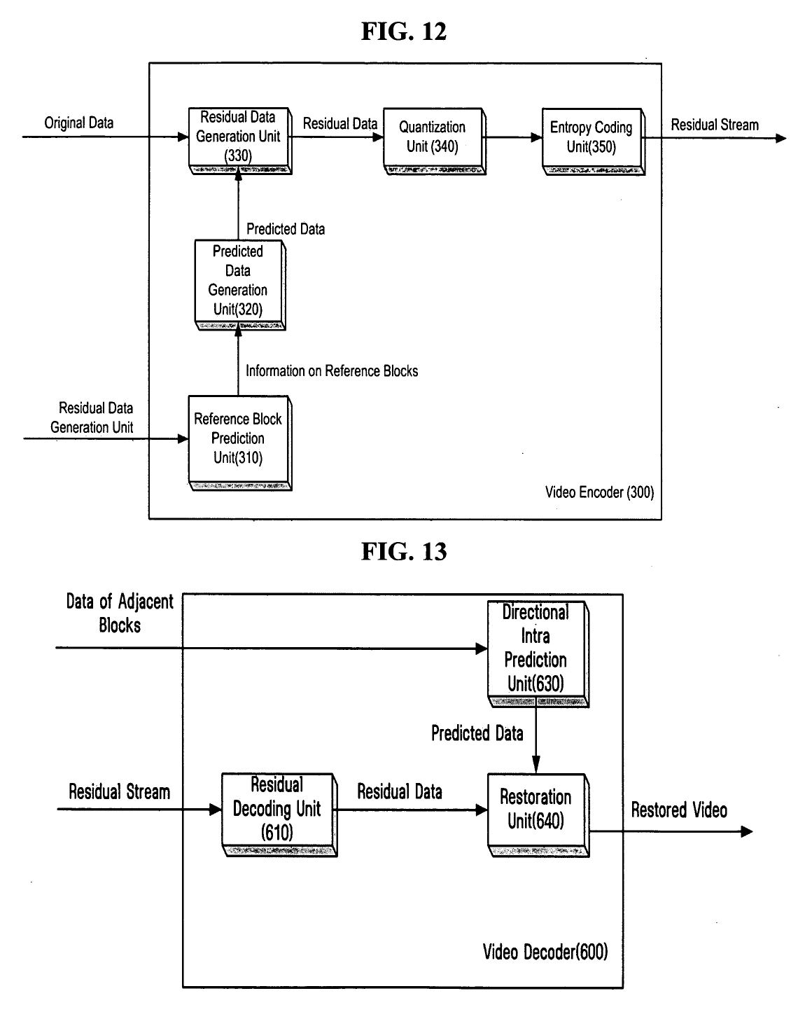

FIG. 12 is a block diagram illustrating the construction of a video encoder according to an exemplary embodiment of the present invention. The video encoder will now be explained around the encoding part of the current layer. The video encoder 500 includes a reference block prediction unit 310, a predicted data generation unit 320, a residual data generation unit, a quantization unit 340, and an entropy coding unit 350.

The reference block prediction unit 310 searches for a second block in a frame in order to predict information of a first block included in the video data from the second block that exists in the same frame as the first block. Here, the first block is data to be encoded, and the second block is a reference block that generates the predicted data.

The residual data generation unit 330 calculates the residual between information included in the searched second block and the information included in the first block.

The quantization unit 340 quantizes the calculated residual, and the entropy coding unit 350 performs a lossless compression by performing an entropy-coding of the quantized residual.

The residual data generation unit 330, the quantization unit 340, and the entropy coding unit 350 may constitute a residual encoding part.

The reference block prediction unit 310 searches the second block in a third direction existing between a first direction and a second direction that are adjacent to each other for use in the H.264 directional intra-prediction when searching the second block that the first block refers to.

If two or more second blocks exist, the predicted data generation unit 320 generates data for predicting the first block by giving weight values to parts of the second blocks that affect the first block.

The residual data generation unit 330 generates the most probable mode value.

The residual data generation unit 330 refers to blocks adjacent to the first block in order to select the most probable mode value, and obtains residual values among the referred blocks, which exist according to the first, second, or third direction.

The most probable mode value may be a median value of the left, upper, and upper right adjacent blocks of the first block, or may be a median value of the left, upper left, and upper adjacent blocks, as shown in FIG. 7.

FIG. 13 is a block diagram illustrating the construction of a video decoder according to an exemplary embodiment of the present invention. The video decoder will now be explained around the decoding part of the current layer.

In the video decoder 600 that has received data of adjacent blocks and a residual stream, a residual decoding unit 610 decodes residual data of the first block included in the residual stream. The first block is a block to be decoded.

A directional intra-prediction unit 630 refers to the second block, and predicts video information of the first block included in the same frame as the second block. The directional intra-prediction unit refers to neighboring blocks in order to perform the directional intra-prediction.

A restoration unit 640 restores the video information of the first block by adding the residual data and the predicted data.

Here, the directional intra-prediction unit 630 predicts directions including the above-described extended directions.

If two or more second blocks exist, the directional intra-prediction unit 630 generates data for predicting the first block by giving weight values to parts of the second blocks that affect the first block.

As described above, according to the exemplary embodiments of the present invention, an accurate prediction can be performed during the directional intra-prediction.

Also, the encoding efficiency can be increased by reducing the size of the residual with reference to information of more adjacent blocks when the most probable mode value is set.

The exemplary embodiments of the present invention have been described for illustrative purposes, and those skilled in the art will appreciate that various modifications, additions and substitutions are possible without departing from the scope and spirit of the invention as disclosed in the accompanying claims. Therefore, the scope of the present invention should be defined by the appended claims and their legal equivalents.

What is claimed is:

1. A method of performing directional intra-prediction when encoding video data, the method comprising:
searching for a second block in a frame of the video data in order to predict information of a first block in the frame from the second block;
calculating a residual between information of the second block and the information of the first block; and
encoding the residual,
wherein the second block exists in a position adjacent to the first block, and the first block refers to the second block in a third direction existing between a first direction and a second direction which are adjacent to each other for use in the directional intra-prediction.

2. The method of claim 1, further comprising, if at least two second blocks exist, generating data which predicts the first block by giving weight values to the second blocks according to the position of the second block and the third direction.

3. The method of claim 1, wherein the first and second directions are determined according to H.264 intraprediction structure.

4. The method of claim 1, wherein the encoding comprises:
encoding a most probable mode value with one bit; and
encoding a value of the first, second or third direction with four bits,
wherein the first, second or third direction is selected according to the most probable mode value.

5. The method of claim 4, wherein blocks adjacent to the first block are referred to in order to select the most probable mode value, and residual values among the referred blocks, which exist according to the first, second, or third direction, are encoded.

6. The method of claim 4, wherein the most probable mode value is a median value of left, upper, and upper right adjacent blocks of the first block.

7. The method of claim 4, wherein the most probable mode value is a median value of left, upper left, and upper adjacent blocks of the first block.

8. The method of claim 4, further comprising:
calculating a bit cost for obtaining a residual between one of a median value of left, upper, and upper right adjacent blocks of the first block and a third block, and a bit cost for obtaining a residual between a median value of left, upper left, and upper adjacent blocks of the first block and the third block, wherein the first and third blocks are positioned in an enhancement layer and a lower layer of the video data, and the third block is a corresponding block of the first block; and
selecting a minimum bit cost as a result of the calculating, wherein the third direction is determined according to the minimum bit cost.

9. A method of decoding video data encoded according to directional intra-prediction, the method comprising:
decoding residual data of a first block included in the video data;
predicting video information of the first block by referring to a second block in a same frame as the first block; and
restoring video information of the first block by adding the residual data and the predicted video information,
wherein the second block exists in a position adjacent to the first block, and the first block refers to the second block in a third direction existing between a first direction and a second direction which are adjacent to each other for use in the directional intra-prediction.

10. The method of claim 9, further comprising, if at least two second blocks exist, generating data which predicts the first block by giving weight values the second blocks according to the position of the second block and the third direction.

11. The method of claim 9, wherein the first and second directions are determined according to H.264 intraprediction structure.

12. The method of claim 9, wherein the decoding comprises:
decoding a most probable mode value with one bit; and
extracting a four-bit decoded value of the first, second or third direction,
wherein the first, second or third direction is selected according to the most probable mode value.

13. The method of claim 12, wherein blocks adjacent to the first block are referred to in order to select the most probable mode value, and residual values among the referred blocks, which exist according to the first, second, or third direction, are decoded.

14. The method of claim 12, wherein the most probable mode value is a median value of left, upper, and upper right adjacent blocks of the first block.

15. The method of claim 12, wherein the most probable mode value is a median value of left, upper left, and upper adjacent blocks of the first block.

16. The method of claim 12, further comprising:
calculating a bit cost for obtaining a residual between one of a median value of left, upper, and upper right adjacent blocks of the first block and a third block, and a bit cost for obtaining a residual between a median value of left, upper left, and upper adjacent blocks of the first block and the third block, wherein the first and third blocks are positioned in an enhancement layer and a lower layer of the video data, and the third block is a corresponding block of the first block; and
selecting a minimum bit cost as a result of the calculating, wherein the third direction is determined according to the minimum bit cost.

17. A method of hierarchically encoding video data, the method comprising:
quantizing data of a lower layer;
calculating a first error range produced in the quantizing of the data of the lower layer; and
quantizing data of an enhancement layer,
wherein the quantizing of the data of an enhancement layer is not performed with respect to a quantization area corresponding to the first error range, and the quantized data of the enhancement layer is disposed in an area having a second error range which does not overlap the first error range.

18. The method of claim 17, wherein the lower layer is a base layer.

19. The method of claim 17, wherein a range for the quantizing of the data of the enhancement layer is included in the second error range.

20. A method of hierarchically decoding video data, the method comprising:
dequantizing data of a lower layer; and
dequantizing an enhancement layer which refers to the lower layer,
wherein a second error range of the enhancement layer succeeds a first error range of the lower layer without overlapping the first error range.

21. A video encoder for performing directional intra-prediction in encoding video data, the video encoder comprising:
a reference block prediction unit which searches for a second block in a frame of the video data in order to predict information of a first block in the frame from the second block; and
a residual encoding unit which calculates a residual between information of the second block and the information of the first block, and encodes the residual,
wherein the second block exists in a position adjacent to the first block, and the reference block prediction unit searches for the second block in a third direction existing between a first direction and a second direction which are adjacent to each other for use in the directional intra-prediction when searching for the second block which the first block refers to.

22. The video encoder of claim 21, further comprising, if at least two second blocks exist, a predicted data generation unit which generates data that predicts the first block by giving weight values to the second blocks according to the position of the second block and the third direction.

23. The video encoder of claim 21, wherein the first and second directions are determined according to H.264 intraprediction structure.

24. The video encoder of claim 21, wherein the residual encoding unit encodes a most probable mode value with one bit and a value of the first, second or third direction with four bits, and
wherein the first, second or third direction is selected according to the most probable mode value.

25. The video encoder of claim 24, wherein the residual encoding unit refers to blocks adjacent to the first block in order to select the most probable mode value, and encodes residual values among the referred blocks, which exist according to the first, second, or third direction.

26. The video encoder of claim 24, wherein the most probable mode value is a median value of left, upper, and upper right adjacent blocks of the first block.

27. The video encoder of claim 24, wherein the most probable mode value is a median value of left, upper left, and upper adjacent blocks of the first block.

28. The video encoder of claim 24, wherein the residual encoding unit calculates a bit cost for obtaining a residual between one of a median value of left, upper, and upper right adjacent blocks of the first block and a third block, and a bit cost for obtaining a median value of left, upper left, and upper adjacent blocks of the first block and the third block,
wherein the first and third blocks are positioned in an enhancement layer and a lower layer of the video data, and the third block is a corresponding block of the first block, and
wherein the residual encoding unit further selects a minimum bit cost as a result of the calculating, wherein the third direction is determined according to the minimum bit cost.

29. A video decoder for decoding video data encoded according to directional intra-prediction, the video encoder comprising:
a residual decoding unit which decodes residual data of a first block included in the video data;
a directional intra-prediction unit which predicts video information of the first block by referring to a second block included in a same frame as the first block; and
a restoration unit which restores video information of the first block by adding the residual data and the predicted video information,
wherein the second block exists in a position adjacent to the first block, and the first block refers to the second block in a third direction existing between a first direction and a second direction which are adjacent to each other for use in the directional intra-prediction.

30. The video decoder of claim 29, wherein, if at least two second blocks exist, the directional intra-prediction unit generates data which predicts the first block by giving weight values to the second blocks according to the position of the second block and the third direction.

31. The video decoder of claim 29, wherein the first and second directions are determined according to H.264 intraprediction structure.

32. The video decoder of claim 29, wherein the residual decoding unit decodes a most probable mode value with one bit, and extracts a four-bit decoded value of the first, second or third direction,
wherein the first, second or third direction is selected according to the most probable mode value.

33. The video decoder of claim 32, wherein the residual decoding unit refers to blocks adjacent to the first block in order to select the most probable mode value, and decodes residual values among the referred blocks, which exist according to the first, second, or third direction.

34. The video decoder of claim 32, wherein the most probable mode value is a median value of left, upper, and upper right adjacent blocks of the first block.

35. The video decoder of claim 32, wherein the most probable mode value is a median value of left, upper left, and upper adjacent blocks of the first block.

36. The video decoder of claim 32, wherein the residual decoding unit calculates a bit cost for obtaining a residual between one of a median value of left, upper, and upper right adjacent blocks of the first block and a third block, and a bit cost for obtaining a median value of left, upper left, and upper adjacent blocks of the first block and the third block,
wherein the first and third blocks are positioned in an enhancement layer and a lower layer of the video data, and the third block is a corresponding block of the first block, and
wherein the residual decoding unit further selects a minimum bit cost as a result of the calculating, wherein the third direction is determined according to the minimum bit cost.
